(19) United States
(12) Patent Application Publication
(10) Pub. No.: US 2007/0156606 A1
(43) Pub. Date: Jul. 5, 2007

(54) METHOD OF SECURING A CHECK TRANSACTION

(75) Inventor: Larry J. Kane, Marion, IA (US)

Correspondence Address: ZARLEY LAW FIRM P.L.C., CAPITAL SQUARE, 400 LOCUST, SUITE 200, DES MOINES, IA, 50309-2350, US

(73) Assignee: Larry J. KANE, Marion, IA (US)

(21) Appl. No.: 11/306,482

(22) Filed: Dec. 29, 2005

(51) Int. Cl. G06Q 99/00

(52) U.S. Cl. 705/74

(57) ABSTRACT

A method of securing a check transaction where an On-Us financial institution establishes checking account information for a consumer. The checking account information is transmitted to a service provider. The service provider creates a virtual account for the checking account that is used in a financial transaction. The financial transaction is processed until the virtual account reaches the On-Us financial institution. The service provider then provides the checking account information to the On-Us financial institution based upon the virtual account received.

### BACKGROUND OF THE INVENTION

This invention is directed toward a method of securing a check transaction, and more specifically to a security method that uses a virtual or alternative account number.

Presently, approximately 5 billion transactions are originated over the Internet where a checking account is used for payment. These transactions, sometimes referred to as e-checks, contain the actual checking account information of the consumer. Use of actual checking account information, particularly over the Internet, creates a tremendous opportunity for fraud and theft.

For a typical e-check transaction, the account number is potentially viewed by a merchant at the point of transaction, the depository financial institution, any intermediary processor, the Federal Reserve, as well as the On-Us financial institution that originated the account. All of these are potentially unsecured recipients where the confidentiality of the account number may be compromised. Accordingly, there exists a need in the art for a method and system that addresses these concerns.

An objective of this invention is to provide a system that secures check transactions from the risk of theft and fraud.

Another objective is to provide a consumer with a system of preventing check fraud that is convenient to use.

A still further objective is to provide a security system for check transactions which does not slow down the time for a transaction.

These and other objectives will be apparent to those skilled in the art based on the following written description.

### SUMMARY OF THE INVENTION

A method of securing a check transaction where an On-Us financial institution establishes checking account information for a consumer. The checking account information is transmitted to a service provider. The service provider creates a virtual account for the checking account that is used in a financial transaction. The financial transaction is processed until the virtual account reaches the On-Us financial institution. The service provider then provides the checking account information to the On-Us financial institution based upon the virtual account received.

### BRIEF DESCRIPTION OF THE DRAWINGS

FIG. 1 is a schematic diagram illustrating the operating environment of a method for securing a check transaction; and

FIG. 2 is a flow chart illustrating a method for securing a check transaction.

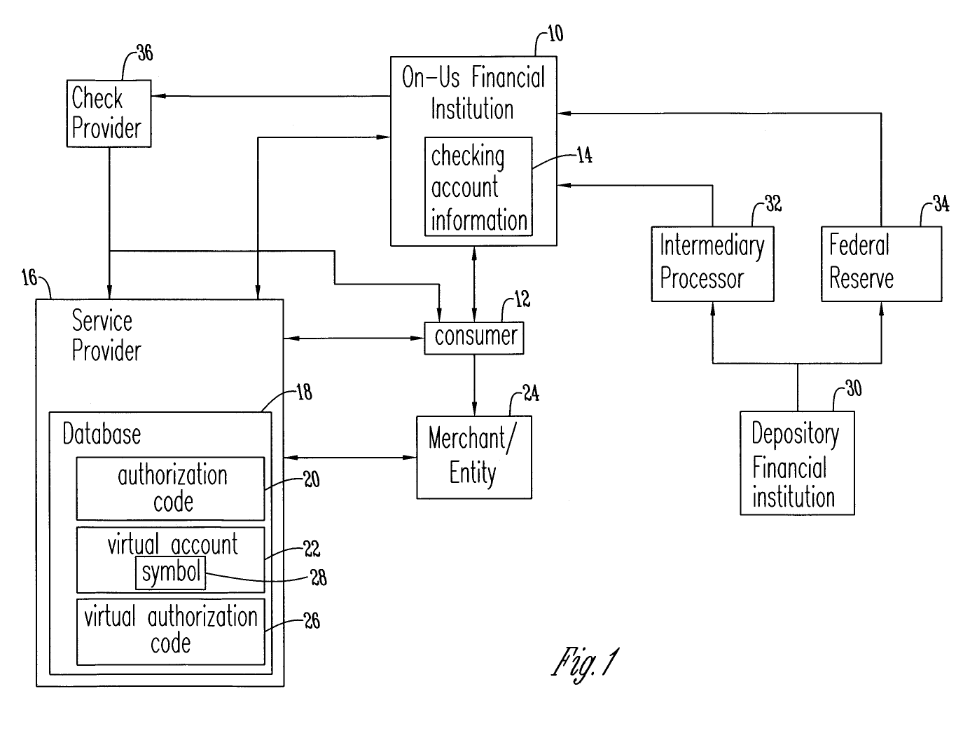

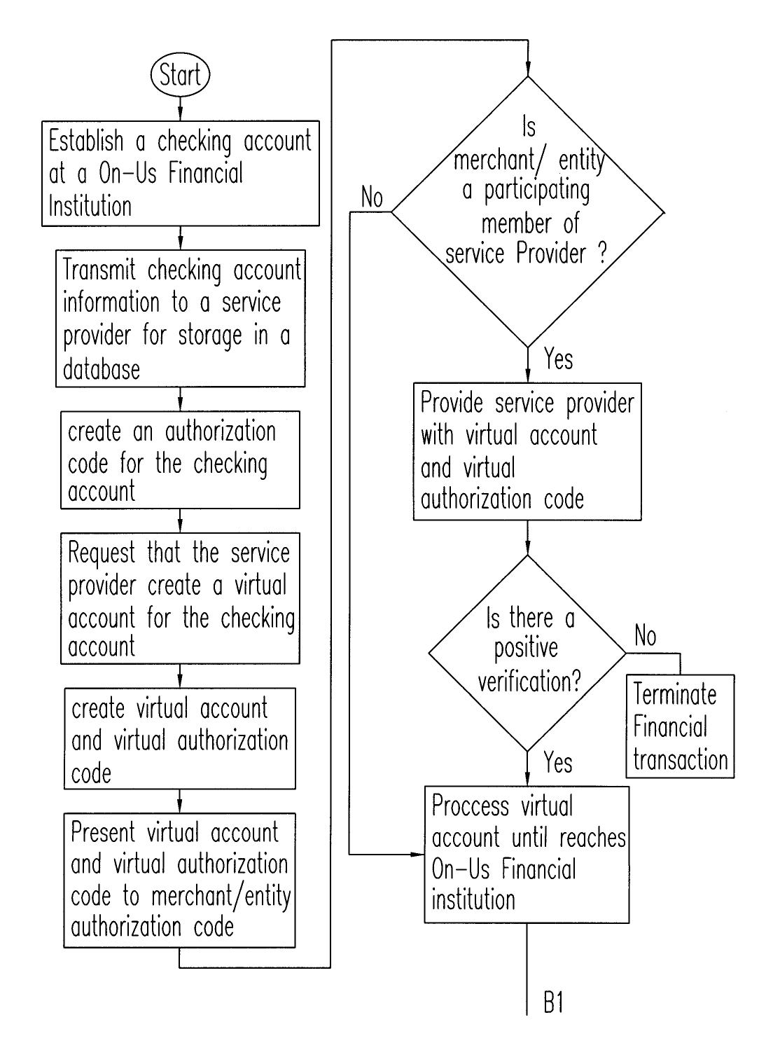

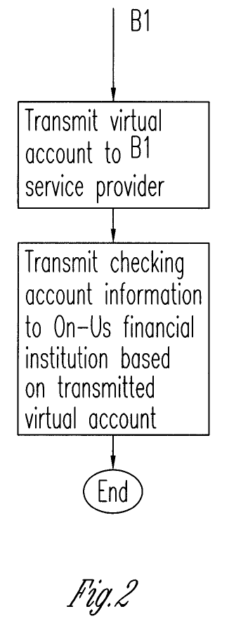

### DETAILED DESCRIPTION OF THE PREFERRED EMBODIMENTS

Referring to the Figures, a checking account is generally established by an On-Us financial institution 10 when a consumer 12 applies for an account and is approved by the On-Us financial institution 10. Once the checking account is established, the checking account information 14 is transmitted to a service provider 16 preferably over an electronic network where the information is stored in a database 18. Alternatively, a consumer 12 may establish a checking account directly with a service provider 16.

Preferably, the service provider 16 is an independent third party at a remote location. Alternatively, the service provider 16 is part of the On-Us financial institution 10. An authorization code 20 such as a word, number, or key is provided to the consumer 12 so that the consumer may interact with the service provider 16. Preferably, the authorization code 20 is created by the service provider 16 and given to the consumer 12 for future use. Alternatively, the On-Us financial institution 10 can create the authorization code 20 and give to both the consumer 12 and the service provider 16.

When a consumer 12 wishes to make a secure transaction they contact the service provider 16 in any conventional manner such as by phone or Internet. The transaction can be of any type such as a purchase over the Internet or at a retail outlet, a deposit from an employer, or an automatic withdrawal. By providing the authorization code 20 and checking account information 14 the consumer 12 is authorized by the service provider to proceed.

Once authorized, the consumer 12 selects from different options regarding the type of virtual account 22 the consumer 12 wishes the service provider 16 to create. In its most simple form, the consumer 12 requests a single virtual account 22 for all transactions. Alternatively, the consumer may request a virtual account 22 tied to a specific merchant or entity 24, a virtual account 22 for a specific transaction; or multiple virtual accounts for multiple entities 24 and/or transactions. For example, a consumer may create the virtual account 22 for the continuous automatic deposit of a paycheck, a second virtual account 22 to be used for miscellaneous purchases on a trip out of town, and a third virtual account 22 for a specific purchase made over the Internet. A consumer 12 may also request a specific number, word, or key be used as the virtual account 22. For example, a consumer may use a number taken from any card having a magnetic strip (i.e., credit card, debit card, driver's license, etc.) and use that number as the virtual account. In this instance, a consumer 12 would be able to use the card with a magnetic strip at a retail establishment to authorize a withdrawal from a checking account. For example, when a consumer 12 goes to check out they could pass their credit card through a reader and indicate that it is a checking and not a credit card transaction. This would speed up the time of check out as less time would be needed than to write out and verify a paper check. Another option a consumer 12 would have is to set a time limit on the virtual account 22 before it would terminate.

Once the consumer 12 selects the type of virtual account or accounts 22, the service provider 16 creates the virtual checking account 22 as well as a virtual authorization code 26 such as a number, word, or key which is provided to the consumer 12 and stores this information in the database 18.

To make a secured transaction the consumer 12 provides the virtual account number 22 to a merchant or entity 24. In some transactions the consumer will also be required to provide the virtual authorization code 26. If the merchant or entity 24 is a participating member of the service provider 16, then the merchant 24 submits the virtual account number 22 and virtual authorization code 26, preferably over an electronic network, to the service provider 16. A symbol or code 28, such as a series of numbers or letters would provide an indication to the merchant that they have been provided a virtual account 22 that was created by the service provider 16. The service provider will compare the virtual account 22 and the virtual authorization code 26 with the information contained in the second database 18. Based on the comparison the service provider 16 will provide the merchant 24 with a signal verifying whether the transaction is authorized. If authorized, the merchant 24 may request or may automatically be provided with the actual checking account information 14.

If the merchant/entity 24 is not a participating member, or after the transaction has been verified by the service provider 16, then the virtual account information 22 proceeds through normal processing. The virtual account information 22 is sent to a depository financial institution 30. If the depository financial institution 30 is not the On-Us financial institution 10 then the virtual account information 22 is sent to the On-Us financial institution 10 through an intermediary processor 32 or the Federal Reserve 34. Once the virtual account information 22 reaches the On-Us financial institution 10 the virtual account information is provided to the service provider 16. The service provider 16 then provides the On-Us financial institution 10 with the actual checking account information 14 so that the transaction may be completed.

Alternatively, the On-Us financial institution 10, a check provider 36, or the consumer 12, may request that the service provider 16 create a virtual account. For example, before printing checks, a check provider 36 would request that the service provider 16 create a virtual account 22 for an individual check (i.e., cashiers check), a set of checks (i.e., travelers checks), or for a box of checks delivered to the consumer.

Therefore, a method has been shown for securing a checking transaction and, at the very least, all of the stated objectives have been met.

What is claimed is:

1. A method for securing a check transaction, the method comprising the steps of:
establishing checking account information for a consumer at an On-Us financial institution;
transmitting the checking account information from the On-Us financial institution to a service provider; and
creating a virtual account at the service provider that is used by the consumer in place of the checking account information during a financial transaction.

2. The method of claim 1 further comprising the step of establishing an authorization code for the checking account.

3. The method of claim 2 further comprising the step of transmitting the authorization code to the service provider.

4. The method of claim 3 further comprising the step of providing the service provider with the checking account information and authorization code before creating the virtual account.

5. The method of claim 1 further comprising the step of creating a virtual authorization code at the service provider.

6. The method of claim 5 further comprising presenting the virtual account and the virtual authorization code to a merchant.

7. The method of claim 6 further comprising the steps of the merchant transmitting the virtual account and virtual authorization code to the service provider, the service provider comparing the virtual account with the virtual authorization code; and the service provider transmitting a verification signal to the merchant.

8. The method of claim 1 further comprising the steps of processing the financial transaction until the virtual account reaches the On-Us financial institution.

9. The method of claim 8 further comprising the steps of transmitting the virtual account from the On-Us financial institution to the service provider and transmitting the checking account information from the service provider to the On-Us financial institution based upon the transmitted virtual account.

10. The method of claim 1 further comprising the step of creating a virtual account based upon a card or other device containing a code, with the code being a word, number, or key.

11. The method of claim 1 wherein the virtual account is set to expire at a predetermined time.

12. The method of claim 1 wherein the virtual account is created for a pre-selected merchant.

13. The method of claim 1 wherein the virtual account is created for a check provider.

14. The method of claim 7 wherein the virtual account is printed on a check.

15. The method of claim 13 wherein the virtual account is printed on a check.

16. The method of claim 1 further comprising the step of a consumer requesting the checking account information be established by the service provider.
